(19) United States
(12) Patent Application Publication
(10) Pub. No.: US 2018/0354036 A1
(43) Pub. Date: Dec. 13, 2018

(54) PRODUCTION METHOD FOR A SHAPING TOOL COMPONENT OF A PRESS HARDENING TOOL

(71) Applicant: Ford Global Technologies, LLC, Dearborn, MI (US)

(72) Inventors: Raphael Koch, Odenthal (DE); Lars Bognar, Dormagen (DE)

(73) Assignee: Ford Global Technologies, LLC, Dearborn, MI (US)

(21) Appl. No.: 15/945,697

(22) Filed: Apr. 4, 2018

(30) Foreign Application Priority Data
Jun. 13, 2017 (DE) 102017209973.9

(51) Int. Cl. B22F 5/00; B22F 3/105; B22D 25/02; B22D 27/04

(52) U.S. Cl. CPC B22F 5/007; B22F 3/1055; B33Y 10/00; B22D 27/04; B22F 2005/002; B22D 25/02

(57) ABSTRACT

The present disclosure provides a production method for a shaping tool component of a press hardening tool that includes producing a preform by an additive production method from metal material. The preform having an outer wall, which at least partially corresponds to a shaping operating face of the tool component. The preform further includes at least one channel wall of a cooling channel adjacent to the outer wall and at least one recess which is at least for the most part further away from the outer wall than the channel wall. After the preform is produced, the at least one recess is filled with liquid metal, which subsequently hardens and forms a portion of the tool component.

### CROSS-REFERENCE TO RELATED APPLICATIONS

This application claims priority to and the benefit of German Patent Application Number 102017209973.9 filed on Jun. 13, 2017. The disclosure of the above application is incorporated herein by reference.

### FIELD

The present disclosure relates to a production method for a shaping tool component of a press hardening tool.

### BACKGROUND

The statements in this section merely provide background information related to the present disclosure and may not constitute prior art.

During the production of a shaped sheet metal component, different method steps can be distinguished. One step relates to the actual shaping of a blank or semi-finished product into the desired form. This shaping can be carried out in one or more stages, wherein a hot forming operation or a cold forming operation is known to be possible. Apart from the adjustment of a specific three-dimensional shape, often, in particular following a hot forming operation, an adjustment of the microstructure is also carried out. In this instance, the workpiece is cooled from a heated state (for example, above the austenitization temperature) in accordance with a provided time/temperature progression. To this end, depending on the type of component and the desired microstructure, different methods are known. Generally, a greater hardness results from the selective cooling, for which reason a hardening or tempering of the workpiece is also referred to.

On the one hand, a subsequent tempering is possible, in which the workpiece is removed from the shaping tool, where applicable heated again and finally cooled (for example, quenched). During press hardening or shaping hardening, the hardening or tempering is carried out inside the shaping tool, directly after or even during the shaping operation. In order to achieve the necessary cooling of the workpiece, the shaping tool has to be cooled in an efficient manner. This is generally carried out by means of cooling channels for a liquid cooling medium (for example, water). In this case, these are ideally intended to extend with a substantially constant, not excessively large spacing from the shaping surface. However, since the path of the shaping surface is generally complex, this cannot be produced by means of simple holes. On the one hand, it is possible to produce the shaping tool component in a single piece, wherein the path of the cooling channels is generally poor, which has an unfavorable effect on the hardening operation and the quality of the workpiece produced. On the other hand, the tool component may be composed of a plurality of individual components, wherein the cooling channels are partially also formed between the individual components. In this instance, although it is in principle possible for any paths of a cooling channel to be produced, as a result of the construction with a plurality of individual components the production complexity increases and consequently also the costs. Another issue is that the shaping surface and the cooling channels are normally at least partially produced by means of a machining processing operation of the tool component. This is costly and linked with a high degree of wear since the tool component has a particularly high level of hardness which is required in order to withstand the loads during a press hardening operation.

U.S. Pat. No. 6,354,361 B1 describes the production of a mold which can be used, for example, during an injection-molding operation. In this instance, by means of an additive production method adjacent to the shaping surface cooling channels are integrated in the mold. There is provision in this instance for metal particles (for example, steel) to first be adhesively bonded by means of a selectively applied binding agent, whereby the intended three-dimensional shape is produced. After removal of the excess powder, the mold may, for example, be sintered or the binding agent can be thermally removed and the intermediate spaces which are produced in this case are filled with a copper alloy. In order to reduce the thermal dissipation, a portion of the mold may have an open structure. It is also possible for only a shell which corresponds to the outer surface of the mold to be produced additively and for the inner space to be subsequently filled, for example, with ceramic material or epoxy resin.

U.S. Patent Publication No. 2013/0255346 A1 describes the additive production of tool components for sheet metal shaping. The tool component is constructed in layers from a polymer or from metal powder, wherein the connection can be carried out, inter alia, by means of laser sintering or electron beam melting. All the embodiments set out solid tool components.

DE 10 2005 041 460 A1 describes a shaping tool system which is suitable in particular for sheet metal processing in the automotive industry. In this instance, at least one tool component has a shaping surface which is formed by means of a mask which is positioned on a back-lining. There is provision for different masks to be able to be selectively used. The back-lining can be produced by means of a metal LOM method.

EP 2 982 463 A2 discloses the production of punching sheets or punching cylinders for a punching device by means of a 3D printing operation. In this instance, either the entire component can be printed or there is used a base member which is prefabricated in a different manner and on which only the punching or cutting lines are printed. The production may in particular be carried out by means of selective laser melting or selective laser sintering. Optionally, after the 3D pressing operation, an engraving operation may be carried out, whereby any tolerances which are present can be compensated for.

U.S. Patent Publication No. 2011/0156304 A1 describes the production of a mold for producing large polymer composite components which are used, for example, in aircraft construction. In this instance, the part of the mold against which the component which is intended to be produced is in abutment is produced by means of additive production.

WO 2008/009101 A1 discloses a shaping tool by means of which a heated sheet metal blank can be shaped. In the shaping tool, close to the shaping surface there are formed cooling channels through which a cooling medium can be directed in order to directly quench the metal sheet directly after the shaping. In this instance, each half of the tool molds has a shell-like outer portion which forms the shaping surface and a separately produced insert whose outer contour substantially coincides with the inner contour of the outer portion. In this instance, there are produced in the surface of the insert a row of grooves which together with the inner surface of the outer portion define the cooling channels.

### SUMMARY

The present disclosure provides efficient production of a shaping tool component for a press hardening tool.

It should be noted that the features and measures set out individually in the following description can be combined with each other in any technically advantageous manner and set out other forms of the present disclosure. The description additionally characterizes and specifies the present disclosure in particular in connection with the figures.

As a result of the present disclosure, a production method for a shaping tool component of a press hardening tool is provided. A press hardening tool in this context is intended to refer to a device which carries out both a hot forming operation of a metal workpiece, normally a sheet metal component, between two mold halves and a hardening or tempering which is carried out at the same time or afterwards. The latter results in the workpiece having to be cooled inside the press hardening tool. The two mold halves may also be referred to as a female mold and a male mold and at least partially enclose the workpiece during the shaping operation. To this end, at least one of the two mold halves is moved in the direction toward the other mold half. The hardening is carried out whilst the workpiece is enclosed between the two mold halves. The shaping tool component which has been produced according to the present disclosure in this instance forms at least a portion of one of the mold halves.

According to the present disclosure, a preform is first produced from metal material by an additive production method. Such a method may also be associated with the field of rapid prototyping or rapid manufacturing. The term “preform” refers to the tool component which is intended to be produced, with regard to which the preform does not represent the final state but instead an intermediate stage. In this case, the production of the preform is normally carried out by a metal powder being applied in layers and selectively connected in regions. As a result of the connection of the individual layers to each other, the three-dimensional preform is produced. Of course, the production process is carried out on the basis of predetermined data (for example, CAM data) of the object which is intended to be produced. A metal powder is intended to be understood in this instance to be any powder-like or particulate material which includes at least one metal. It may also be an alloy or an admixture of particles of different metals. The powder may also contain semi-metals or non-metals, for example, as a component of an alloy. Metals may include, inter alia, aluminum, titanium and iron while still remaining within the scope of the present disclosure, and shall not be limited to the metals mentioned. Accordingly, a metal material is a material which comprises at least one metal.

In one form, in order to produce the desired strength for the tool component, selective laser melting (SLM) is used as the additive production method. Electron beam melting (EBM) can also be used. In this instance, a metal powder is applied in layers and selectively melted in accordance with the provided three-dimensional shape. An application device applies a layer having a thickness, for example, between 10 μm and 500 μm, but other layer thicknesses are also possible. In order to enable a smooth and uniform layer construction, the application device may comprise a smoothing device, for example, a scraper, brush or blade, which is moved parallel with the construction face and smoothes the surface of the powder. The application is carried out in this instance in layers on a base member (normally a base plate), that is to say, the first layer is applied directly to the base member, after which the additional layers are applied successively one over the other. After the application of a respective layer, the powder is partially melted by a laser beam (in SLM) or electron beam (in EBM) and subsequently hardens. In this manner, a coherent solid body is formed by the powder. At the same time, the powder of the layer which has been added last is melted with the solid body structures of the layer below or plurality of layers below, whereby a retention of the layers with each other is produced. Inter alia in accordance with the layer thickness, it is possible for the material to be melted up to a depth which corresponds to a plurality of layer thicknesses.

The base member not only forms a mechanical base for the production of the object, instead it may also have an important function for dissipating heat. By heat dissipation on the base member, excessive heating of the preform and consequently also a thermally related deformation, for example, bending, can be substantially reduced. Normally, during the additive production method, there are also produced support structures which are connected to the base member and where applicable can be removed later. The support structures may be used, on the one hand, to stabilize the preform during the production but, on the other hand, they may also improve the thermal connection to the base member so that heat can be better discharged. Furthermore, the support structures can be arranged between the base member and the usable portion of the preform so that the preform is connected only indirectly via the support structures to the base member. It is thereby possible in a simpler manner to separate the usable portion of the preform from the base plate without damage. Such support structures may, for example, be in the form of supports, stilts, webs or the like. They may also have an open, for example, grid-like, net-like or honeycomb-like structure.

Alternatively, or additionally to SLM or EBM, other production methods, such as, for example, selective laser sintering (SLS) can also be used.

The preform produced has an outer wall which at least partially corresponds to a shaping operating face of the tool component, at least one channel wall of a cooling channel adjacent to the outer wall and at least one recess which is at least for the most part further away from the outer wall than the channel wall. The outer wall corresponds in this instance to an outer region of the tool component which is intended to be produced. A region of the outer wall corresponds in this instance to the shaping operating face of the tool component. In this case, the operating face is the portion of the surface of the tool component which comes into contact with the workpiece during the press hardening operation and consequently determines or co-determines the shaping. Other portions of the outer wall may be directly or indirectly adjacent to the operating face in this case. The outer wall may in particular be constructed in a shell-like manner.

In addition to the outer wall, the preform has a channel wall of a cooling channel. Such a cooling channel is provided in the context of the press hardening operation to direct a cooling agent (for example, water or admixtures therewith). Of course, a plurality of cooling channels may also be provided. Via the at least one cooling channel, primarily the region of the operating face and consequently secondarily also the workpiece which is in contact therewith is cooled. In one form, to carry out the cooling, the cooling channel extends at least partially adjacent to the outer wall, in particular adjacent to the operating face. In this instance, it is possible for a portion of the outer wall to define the cooling channel together with the channel wall. The channel wall may be set back from the outer wall or both walls may be part of a material layer in which the at least one cooling channel extends. Alternatively, it is also conceivable for the channel wall to extend adjacent to the outer wall, but with spacing therefrom. In this instance, the channel wall has to be connected at least partially to the outer wall by one or more connection webs.

Furthermore, the preform has a recess which is at least for the most part further away from the outer wall than the channel wall. This means that a predominant proportion (that is to say, more than half) of the recess is further away from the outer wall than the channel wall. It could also be said that the recess when viewed from the outer wall is arranged beyond the channel wall. Whilst the channel wall is thus arranged adjacent to the outer wall, at least a predominant proportion of the recess is further away. This does not exclude portions of the recess also being arranged adjacent to the channel wall. The at least one recess corresponds in this instance to a region in which during the additive production method no coherent body is produced, that is to say, in the case of SLM or EBM there is no melting of the powder. In this instance, the recess until the end of the additive production remains filled with powder which can subsequently be removed. After the powder has been removed, such a recess forms an empty space which is normally partially enclosed by the outer wall. It is expressly possible for a plurality of such recesses to be provided. Within a recess, fixed structures may also be provided, for example, above-mentioned support structures or connection webs between a channel wall and the outer wall.

After the preform has been completed by the additive production method, according to the present disclosure, the at least one recess is filled with liquid metal which subsequently hardens and forms a portion of the tool component. The preform forms in this instance to some extent a vessel for the liquid metal. In one form, the recess is at least for the most part or completely filled with metal. After the hardening of the metal, therefore, the portions of the preform adjacent to the recess are connected to each other in a materially integral or at least positive-locking manner by the introduced metal. It is possible in this instance to use as metals, for example, steel or cast iron. In principle, there can also be used alloys which contain where applicable semi-metals or non-metals. In this regard, instead of a liquid metal it would also be possible to refer to a liquid metal material. The filling may be carried out while the preform is in a container which is filled with sand (or other temperature-resistant material). Before the liquid metal is poured in, the above-mentioned support structures, if present, may optionally be removed. Of course, any powder which remains behind from the additive production can be removed from the preform, in particular from the recess. Under some circumstances, however, it is also acceptable for some powder residues to remain in the recess and to be poured-in in the liquid metal. After the hardening, the metal, which has been poured in, forms part of the tool component so that the entire tool component comprises at least the preform and the poured-in metal.

The method according to the present disclosure combines various advantages. On the one hand, it is possible as a result of the additive production method to produce the outer wall with the at least one cooling channel with a high degree of precision and in any shape. In this instance, in particular a suitable path of the cooling channel close to the surface can be produced. In contrast to a machining production of the cooling channel, a single-piece production is possible without there being any geometric limitations. The additive production is also generally more time-saving than a machining processing operation which starts from a blank or a semi-finished product. A significant time advantage of the method is, however, that not the entire provided volume of the tool component is produced in an additive manner, but instead in an extreme case only the outer wall which defines the outer contour of the tool component and the at least one channel wall which defines the path of the cooling channel. In any case, a proportion of the provided volume is omitted (that is to say, the portion which corresponds to the at least one recess) and is subsequently filled with metal. Of course, the filling with metal can be carried out significantly more quickly than filling the corresponding volume with an additive production method.

In principle, the pouring of the liquid metal in the recess can be carried out from different sides as long as the recess has a corresponding opening at that location. In one form, at least one recess having an opening at a side remote from the operating face is produced, wherein the liquid metal is poured in through the opening. If the side with the operating face is referred to as the front side, the opening is therefore at the rear side. The respective recess is accessible via the mentioned opening so that a pouring of the liquid metal is thereby possible. In this instance, there is no impairment of the operating face, that is to say, it can at least be produced substantially in the form in which it is intended to be used within the press hardening tool.

Under some circumstances, the surface of the outer wall, in particular in the region which corresponds to the operating face, deviates slightly from the provided shape. This may, for example, be a result of the fact that, as a result of the layered structure, no precisely smooth surfaces are produced. It is also conceivable for the outer wall to become slightly distorted as a result of the filling with liquid metal and the subsequent hardening and cooling of this liquid metal. In order to overcome any imprecisions, there is provision in one form of the method for the surface of the outer wall to be reprocessed in an erosive manner after it has been produced. The reprocessing operation may in this instance be carried out in a machining manner, for example, by milling.

The reprocessing operation is carried out after the filling and the hardening of the metal, according to one form. On the one hand, any imprecisions resulting from the filling and the hardening can thereby be overcome. On the other hand, in particular in those cases in which the outer wall is particularly thin, the processing can be better carried out on the filled tool component, since it is mechanically more stable.

The method according to the present disclosure may in particular be used in connection with press hardening tools which are constructed in a modular manner, wherein the tool component produced constitutes a module which can be replaced in a comparatively simple manner, depending on which type of shaping is desired. In this instance, structures can be produced on the tool component for connection to a base portion of the press hardening tool. The base portion in this instance constitutes a portion of the press hardening tool which is intended to be permanently fitted thereto. The base portion may be stationary or movable. In any case, it is provided so that different tool components can be selectively assembled thereon, normally by screwing. In this instance, the structures may be holes through which screws can be guided.

Structures such as the above-mentioned holes may be produced in the context of a reprocessing operation, for example, by a drill. Advantageously, however, the structures are produced by the additive production method. That is to say, they are already produced on the basis of corresponding three-dimensional data before the at least one recess is filled. The entire production process is thereby simplified and time is saved. Furthermore, wear of a processing tool is eliminated.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective illustration of a tool component constructed in accordance with the principles of the present disclosure;

FIG. 2 is a partial sectioned illustration of a production installation having a preform for the tool component of FIG. 1;

FIG. 3 is a sectioned illustration of the preform of FIG. 2;

FIG. 4 is a partial illustration of the preform of FIG. 3 during a filling operation;

FIG. 5 is a schematic illustration of the tool component of FIG. 1 and a milling tool; and

FIG. 6 is a sectioned illustration of a press hardening tool with the tool component of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

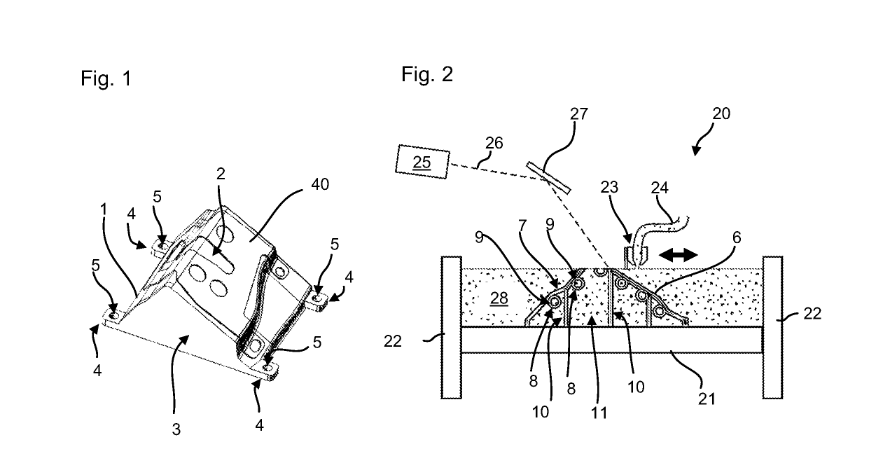

FIG. 1 is a perspective illustration of a tool component 1 which can be produced using the method according to the present disclosure. In this case, the tool component 1 forms a portion of a male mold of a press hardening tool 14 (illustrated in FIG. 6). Using the press hardening tool 14, a sheet metal component 40 can be hot-formed and hardened. The shaping takes place inter alia on an operating face 2 of the tool component 1 which is flanked by side faces 3. The tool component 1 also has four continuations 4 with through-openings 5.

In order to produce the tool component 1, a preform 6 is first produced within a production installation 20 which is illustrated in FIG. 2 in a highly schematic manner. The production may be carried out in this case by selective laser melting (SLM). On a base plate 21 which can be moved in a vertical manner, metal powder 28 is applied in layers by an application device 23. The metal powder 28 may, for example, be a steel powder. The application device 23 is connected to a supply line 24 for metal powder 28 and, as indicated by the double-headed arrow, can be moved in a horizontal direction. It may have a type of nozzle or valve for dispensing powder and a smoothing device, for example, a scraper. In order to inhibit the metal powder 28 from laterally trickling off the base plate 21, stationary side walls 22 are provided.

When the application device 23 has applied a layer of metal powder 28, using a laser beam 26, a portion of the powder 28 is selectively melted, whereby a layer of the preform 6 which is intended to be produced is produced. The laser beam 26 is produced by a laser 25 and directed by a pivotable mirror 27 onto a provided coordinate location within the surface of the metal powder 28. The activation of the laser 25 and the control of the mirror 27 are carried out in this instance in a computer-controlled manner in accordance with predetermined CAM data of the preform 6. The base plate 21 is in the present example operated in an intermittent manner, that is to say, it is stopped whilst a powder layer is applied and partially melted and subsequently moved downward by a distance which corresponds to the provided layer thickness.

The preform 6 produced has an outer wall 7 which substantially corresponds to the path of the operating face 2 and the path of the side walls 3. Furthermore, in a state adjacent to the outer wall 7 there are produced a series of channel walls 8 which in this instance merge into the outer wall 7. Each channel wall 8 defines (together with the outer wall 7) a cooling channel 9. As can be clearly seen in FIG. 2, there remains during the production operation a recess 11 which is partially enclosed by the outer wall 7 and which is for the most part further away from the outer wall 7 than the channel walls 8. Smaller part-regions of the recess 1 are in this instance arranged between the channel walls 8 in the vicinity of the outer wall 7.

As a result of the action of the laser beam 26, the preform 6 produced is heated powerfully, although the molten powder 28 hardens again when the action of the laser beam 26 is ended. An effective heat discharge is not possible either to the surrounding powder 28 or to the surrounding atmosphere (which may, for example, comprise inert gas). Therefore, in order to inhibit thermally related deformations of the preform 6, it is advantageous to support the heat discharge to the base plate 21 by support structures 10 which are connected to the base plate 21 being produced. These support structures 10 on the one hand stabilize the preform 6, but above all they are used for better heat discharge into the base plate 21. The support structures 10 may further serve to space apart the usable portion of the preform 6 from the base plate 21 so that, after the production is complete, the preform 6 can be separated without the usable portion being damaged. Furthermore, it may be advantageous to use the support structures 10 at locations or surfaces which have an angle of less than approximately 45° with respect to the base plate 21. In FIG. 2, three support structures 10 are illustrated only schematically, wherein additional ones may be arranged outside the place of section.

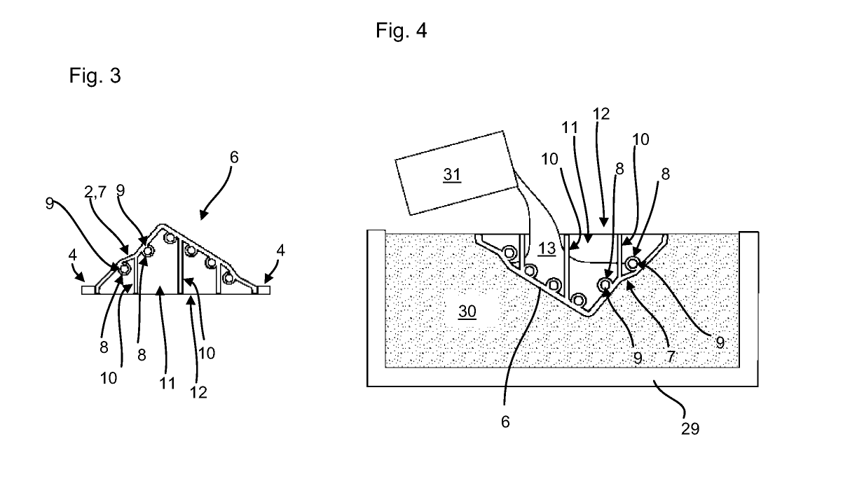

FIG. 3 shows the completed preform 6 which has been released from the base plate 21. This preform already has the continuations 4 with the through-openings 5 (FIG. 1) as produced during the additive production operation. It can also be seen that the recess 11 has at a side remote from the operating face 2 a relatively large opening 12. As a result of the recess 11 which has been produced during the production operation, the preform 6 corresponds to only a comparatively small part-volume of the entire tool component 1. In particular, the outer wall 7 may have a thickness which is so small that per se it could not withstand the forces which occur during the shaping of the sheet metal component 40.

The material thickness which is thus lacking in the preform 6 is, as shown in FIG. 4, supplemented by the recess 11 being filled with metal 13. The metal 13 is poured from a crucible 31 in the liquid state into the opening 12. In order to configure the filling operation in an efficient manner, the preform 6 is turned upside down to a degree, and for secure support and for temperature discharge, embedded in a bed, for example, of sand 30 inside a container 29. The metal 13 may, for example, be steel or cast iron. As a result of the presence of the channel walls 8, the inside of the channels 9 remains free, whilst the recess 11 is completely filled with metal 13. After the hardening and cooling of the metal 13, the tool component 1 which is now substantially complete can be removed from the sand 30. In place of sand, other suitable materials can also be used or suitable measures can be carried out for reliable support and temperature discharge.

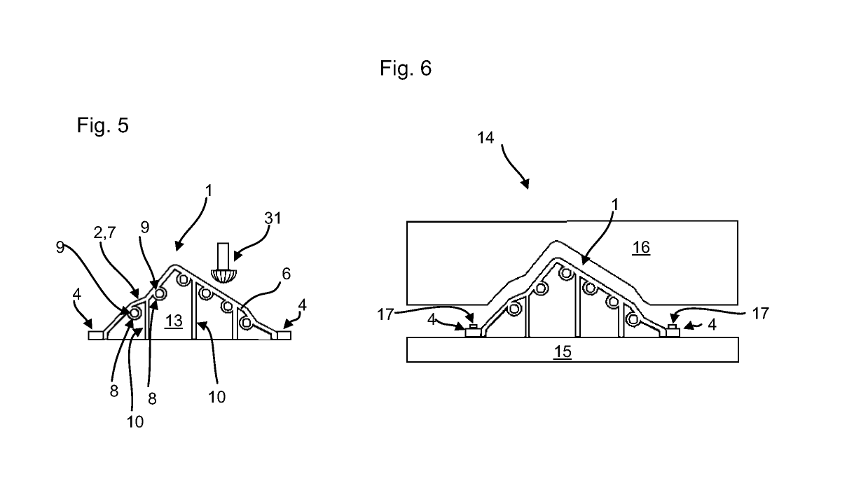

Optionally, as illustrated in FIG. 5, an erosive processing operation of the operating face 2 may be carried out in order to overcome any imprecisions which could occur during the additive production operation or as a result of thermal deformations during filling.

FIG. 6 illustrates in a highly schematic manner the entire press hardening tool 14 in which the tool component 1 is assembled in a modular manner with a stationary base portion 15. To this end, screws 17 are guided through the through-openings 5 and screwed to the base portion 15. During the shaping operation, the sheet metal component 40 of FIG. 1 (for example, after previous austenitization) is shaped between the tool component 1 and a vertically displaceable female mold 16. The female mold 16 is in this instance illustrated as a solid integral component, but could also be produced in a similar manner to the tool component 1. During the shaping operation or directly afterwards, a cooling medium (for example, water or admixtures therewith) is directed through the cooling channels 9, whereby a significant cooling of the operating face 2 and consequently also of the sheet metal component 40 is carried out. As a result of the additive production of the preform 6, the cooling channels 9 may extend with efficient spacing with respect to the operating face 2. A machining processing operation of the tool component 1 can be reduced. Since a large portion of the volume of the tool component 1 is filled by being filled with metal 13, it can on the whole be produced within a short time. Consequently, modular tool components 1 which can be combined with the base portion 15 can be produced in a relatively rapid and cost-effective manner.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A production method for a shaping tool component of a press hardening tool, the production method comprising:
producing a preform from metal material by an additive production method, the preform comprising:
an outer wall at least partially corresponding to a shaping operating face of the tool component;
at least one channel wall of a cooling channel adjacent to the outer wall; and
at least one recess, wherein at least half of the recess is located further away from the outer wall than the at least one channel wall; and
filling the at least one recess with liquid metal, wherein the liquid metal subsequently hardens and forms a portion of the tool component.

2. The production method as claimed in claim 1, wherein the additive production method is selective laser melting.

3. The production method as claimed in claim 1, wherein the at least one recess includes an opening at a side remote from the operating face, wherein the liquid metal is poured in through the opening.

4. The production method as claimed in claim 1, wherein a surface of the outer wall is reprocessed by erosive processing after the surface has been produced.

5. The production method as claimed in claim 4, wherein the reprocessing operation is carried out after filling the at least one recess with liquid metal and hardening the liquid metal.

6. The production method as claimed in claim 1 further comprising producing support structures configured to connect a base portion of the press hardening tool to the tool component.

7. The production method as claimed in claim 6, wherein the support structures are produced by the additive production method.

8. The production method as claimed in claim 1, wherein the additive production method is electron beam melting or selective laser sintering.

9. A production method for a shaping tool component of a press hardening tool, the production method comprising:
producing a preform made of a metal material by an additive production method, the preform comprising:
an outer wall corresponding to an operating face of the tool component;
a plurality of channel walls, each channel wall defining a cooling channel that merges into the outer wall; and
at least one recess partially enclosed by the outer wall and defining an opening;
producing at least one support structure within the at least one recess of the preform by the additive production method; and
pouring liquid metal through the opening defined by the recess to fill at least a portion of the recess with liquid metal, wherein the liquid metal subsequently hardens and forms a portion of the tool component.

10. The production method as claimed in claim 9 further comprising removing the at least one support structure before pouring the liquid metal into the recess of the preform.

11. The production method as claimed in claim 9, wherein the additive production method is selective laser melting.

12. The production method as claimed in claim 9, wherein the additive production method is electron beam melting or selective laser sintering.

13. The production method as claimed in claim 9, wherein a surface of the outer wall is reprocessed by an erosive process after the surface has been produced.

14. The production method as claimed in claim 13, wherein the reprocessing is carried out after filling the at least one recess with liquid metal and hardening the liquid metal.

15. The production method as claimed in claim 9 further comprising placing the preform in a container containing a temperature-resistant material before pouring the liquid metal into the recess of the preform.

16. The production method as claimed in claim 15, wherein the preform is placed in the container upside down and embedded into the temperature-resistant material.

17. The production method as claimed in claim 15, wherein the temperature-resistant material is sand.

18. The production method as claimed in claim 15 further comprising removing the preform from the container after the liquid metal hardens and cools.

19. The production method as claimed in claim 9, wherein the preform further comprises at least one continuation, the continuation defining a through-opening.

20. The production method as claimed in claim 9, wherein the outer wall and the channel wall defines the cooling channel.
